(19) United States
(12) Patent Application Publication
(10) Pub. No.: US 2017/0075479 A1
(43) Pub. Date: Mar. 16, 2017

(54) PORTABLE ELECTRONIC DEVICE, CONTROL METHOD, AND COMPUTER PROGRAM

(71) Applicant: LENOVO (Singapore) PTE. LTD., New Tech Park (SG)

(72) Inventor: Yasumichi Tsukamoto, Yamato-shi (JP)

(21) Appl. No.: 15/262,827

(22) Filed: Sep. 12, 2016

(30) Foreign Application Priority Data
Sep. 12, 2015 (JP) 2015-180236

(51) Int. Cl. G06F 3/041; G06F 1/32; G06F 1/16

(52) U.S. Cl. CPC G06F 3/0416; G06F 1/162; G06F 1/1618; G06F 1/1643; G06F 1/3262; G06F 1/3265

(57) ABSTRACT

A portable electronic device includes a first chassis and a second chassis, each chassis having a front surface and a back surface, a directional device arranged on the front surface of the chassis, and a touch sensor arranged on the front surface of the chassis. The device configures the directional device arranged on each front surface in response to determining an orientation of each front surface to a user. A directional device includes a touch screen and a touch sensor includes a touch panel. The device determines an orientation of each front surface based upon the touch sensors on each front surface detecting the number of fingers touching the front surface and their coordinates on the front surface.

The subject matter disclosed herein relates to configuration of a directional device based upon its orientation to a user, where the directional device is mounted on a portable electronic device that can be used while being held with a hand.

### BACKGROUND

A portable electronic device such as a smartphone, a tablet terminal, or a laptop personal computer (a laptop PC) generally has a touch screen and a user operates the portable electronic device while holding its chassis in such a way that the touch screen faces the user. This type of portable electronic device carries a device serving as an input/output interface for a user (hereinafter, referred to as “interface device”) such as a touch screen, a camera, or an audio device. In the case of a certain type of interface device, its configuration is based on the assumption that the touch screen faces a user.

A reduction in thickness is achieved by a dual-screen laptop PC formed by providing a touch screen, instead of a hardware keyboard, on the bottom-side chassis of a laptop PC. In the laptop mode, the PC can be used like a laptop PC by displaying a software keyboard on the touch screen on the bottom-side chassis. In the tent mode, a plurality of users can view one of the touch screens from different directions.

The bottom-side chassis is heavy in weight since a battery unit, a disk drive, and the like are mounted thereon. Therefore, a user is able to place the PC so that the bottom-side chassis is in contact with the desk surface in the laptop mode. Thus, in the laptop mode, the orientation of the two touch screens to the user are settled such that the touch screen on the top-side chassis faces the user and the touch screen on the bottom-side chassis faces upward. The system is able to display the software keyboard on the touch screen on the system chassis and to display an application screen on the touch screen on the display housing based upon the orientation of the touch screens when the PC is in the laptop mode.

In tablet mode, the two touch screens are arranged on opposite sides, and a user typically uses the PC while holding the chassis with one hand. In this state, an interface device is arranged on the front surface or on the back surface. The configuration of interface devices such as a touch screen, a camera, a microphone, and a speaker mounted on the dual-screen laptop PC are determined by the device's orientation to a user.

In the tablet mode, the system is able to appropriately make settings for interface devices if it is presupposed that the laptop PC is held so that one of touch screens predetermined by a user faces the user. Particularly in the case of employing a design of basis of uniformity on the whole, however, it is difficult for the user to hold the laptop PC with the predetermined touch screen facing the user instantaneously or it is inconvenient to hold the laptop PC again appropriately in the case of unsuccessfully holding it. It is desirable that configurations for the interface devices are appropriately made independently of either of the touch screens faces the user while holding the laptop PC.

Specifically describing the touch screens, the user only needs to access the front-surface-side touch screen facing the user in the tablet mode, and therefore it is desirable to stop (i.e., deactivate) the back-surface-side touch screen in order to prevent an erroneous input or to reduce power consumption. The system, having detected the tablet mode, is able to activate one of the touch screens and to stop the other touch screen. Moreover, after the system activates both touch screens once, the user is also able to operate one touch screen by holding the chassis again appropriately, as necessary, to stop the other touch screen. Forcing the user to hold the chassis again appropriately or to perform the operation as described above, however, interferes with a smooth change in the use mode.

If a camera is mounted on each of the system chassis and the display housing, the user who holds the laptop PC in the tablet mode is able to photograph himself/herself or to photograph the environment. Before the system captures image data, a preview screen is displayed on either one of the touch screens. In the case of a user often photographing an environment, the user wants the environment to be displayed on the preview screen when activating the camera. At this time point, the system needs to identify the camera facing the environment out of the two cameras. On the other hand, in the case of a user often photographing himself/herself, the system needs to identify the camera facing the user.

In the case where only one camera is provided, it is possible to photograph a user by displaying a preview screen on a touch screen facing the user. But if the touch screen facing the user is deactivated, then the preview screen cannot be displayed on the touch screen, even if the user tries to photograph the environment by changing the direction of the chassis. As described above, in the dual-screen laptop PC which can be used in the tablet mode, there is an interface device that cannot automatically be configured unless the system determines the touch screen facing the user. Note that, however, the touch screen and the camera are illustrative only of interface devices requiring settings according to the direction of the chassis to the user, and they do not intend to limit the scope of this disclosure.

### SUMMARY

Therefore, it is desirable to provide a portable electronic device that configures an interface (or directional) device in response to determining its orientation relative to a user. It is another object of the present disclosure to provide a portable electronic device not restricting the user's way of holding the chassis. It is still another object of the present disclosure to provide a portable electronic device not requiring any user's setting operation for a directional device after holding the chassis. It is still another object of the present disclosure to provide a portable electronic device capable of reducing the number of cameras. It is still another object of the present disclosure to provide a method and a computer program for configuring directional devices applied to the portable electronic device.

According to an aspect of the present disclosure, there is provided a portable electronic device equipped with a directional device which is arranged on a first or second front surface in a particular use configuration where a chassis is held with a hand and which configures the directional device depending on its orientation relative to the user. The portable electronic device includes: a first touch sensor arranged on the first front surface; a second touch sensor arranged on the second front surface; and a control unit which calculates the number of fingers touching the first and second touch sensors or either one of the touch sensors, recognizes the front surface facing the user or environment, and configures the directional device.

According to the above configuration, if the user naturally holds the chassis, the action of the directional device is controlled according to its orientation to the user. The used state (i.e., use configuration) in which the chassis is held with a hand may be implemented by setting to a tablet mode in a portable electronic device in a multi-use mode or may be implemented in a portable electronic device in which the front surface and the rear surface of a flat-plate-like chassis are a first front surface and a second front surface, respectively. The configuration of the directional device in response to its orientation to a user may include, for example, activating or deactivating a touch screen, controlling a horizontal position so as to be adapted to a user as in a stereo speaker, or controlling the direction and range of a space in which sounds are collected so as to be adapted as in a microphone pair.

If the directional device includes first and second touch screens, the first touch sensor may be a first touch panel constituting the first touch screen and the second touch sensor may be a second touch panel constituting the second touch screen. The chassis may include a first chassis and a second chassis coupled to each other via a hinge mechanism and the portable electronic device may be set in a used state in which the chassis is held with a hand by rotating the hinge mechanism. It can be assumed that a large number of users each hold the chassis with their thumbs on the front surface facing the user. Therefore, the control unit is able to recognize that the front surface where a touch sensor having detected one finger is present faces the user.

It can be assumed that a large number of users each hold the chassis at the peripheral portion. Therefore, the control unit is able to recognize the front surface facing the user with higher probability if the control unit recognizes that the front surface faces the user when the coordinates of one finger, if detected, indicate the peripheral portion of the chassis. The control unit is able to recognize that the front surface having a touch sensor, which has detected one finger in each of the peripheral portions at both ends of the chassis, faces the user. In this case, the control unit is able to recognize the front surface facing the user even if the user holds the chassis with both hands.

It can be assumed that a large number of users each hold the front surface facing the environment with fingers other than the thumb. Therefore, the control unit is able to recognize that the front surface having a touch sensor, which has detected two to four fingers, faces the environment (i.e., away from the user). The length relation of four fingers other than the thumb in holding the chassis can be assumed to be within a certain range. Therefore, the control unit is able to recognize that the front surface faces the environment when a set of a plurality of detected discrete coordinates indicates to be consistent with the shape of fingers holding the chassis. The control unit is able to recognize that the front surface faces the environment when the front surface has a touch sensor which has detected a set of coordinates indicating to be consistent with the shape of an area touched by the palm of the hand holding the chassis. In this case, the control unit is able to recognize that the front surface faces the environment even if the user holds the chassis in such a way that the front surface facing the environment is put on the palm of the hand and on the forearm.

If the directional device includes a camera arranged on the first front surface, the control unit is able to control the second touch screen to display a preview screen when recognizing that the first front surface faces the environment. In this case, even if the camera is mounted only on the first front surface, the environment can be photographed. The control unit is able to control the first touch screen to display a preview screen when recognizing that the first front surface faces the user.

If the directional device includes a first camera arranged on the first front surface and a second camera arranged on the second front surface, the control unit is able to activate the second camera and causes the first touch screen to display a preview screen when recognizing that a photographing mode is set to an environment photographing mode and that the first front surface faces the user.

If the directional device includes a first stereo speaker arranged on the first front surface and a second stereo speaker arranged on the second front surface, the control unit is able to activate the stereo speaker arranged on the front surface recognized to face the user to control panning thereof and to stop the stereo speaker recognized to face the environment. If the directional device includes a first microphone pair arranged on the first front surface and a second microphone pair arranged on the second front surface, the control unit is able to perform different types of beam forming control for the microphone pair arrange on the front surface recognized to face the user and the microphone pair arranged on the front surface recognized to face the environment.

The present disclosure enables the provision of a portable electronic device that configures an operation of a directional device in response to determining its orientation toward a user. Furthermore, the present disclosure enables the provision of a portable electronic device not restricting the user's way of holding a chassis. Still further, the present disclosure enables the provision of a portable electronic device not requiring any user's setting operation for the directional device after holding the chassis. Still further, the present disclosure enables the provision of a portable electronic device capable of reducing the number of cameras. Furthermore, the present disclosure enables the provision of a method and a computer program for configuring a directional device applied to the portable electronic device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, embodiments will be described and explained with additional specificity and detail through the use of the accompanying drawings, in which:

FIG. 1A is a perspective view illustrating an outline of a dual-screen laptop personal computer having a multi-use mode;

FIG. 1B is a back view illustrating an outline of a dual-screen laptop personal computer having a multi-use mode;

FIG. 2A-2G is a diagram for describing a use mode of the laptop personal computer;

FIG. 3 is a diagram for describing a state where a front surface of a laptop faces a user in a tablet mode;

FIG. 4 is a diagram for describing a state where the user holds the laptop computer in the tablet mode;

FIG. 5 is a diagram for describing another state where the user holds the laptop computer in the tablet mode;

FIG. 6 is a diagram for describing yet another state where the user holds the laptop computer in the tablet mode;

FIG. 7 is a schematic functional block diagram of the laptop computer;

FIG. 8 is a master flowchart illustrating a method for a control system of the laptop computer;

FIG. 9 is a flowchart illustrating a method for recognizing that a front surface of a portable electronic device faces a user;

FIG. 10A-10B is a diagram illustrating a method for recognizing that a front surface of a portable electronic device faces a user;

FIG. 11 is a flowchart illustrating a method for recognizing that a front surface of a portable electronic device faces away from a user;

FIG. 12A-12C is a diagram a method for recognizing that a front surface of a portable electronic device faces away from a user; and

FIG. 13 is a flowchart illustrating a method for configuring cameras mounted on a front surface of a portable electronic device.

### DETAILED DESCRIPTION

### Laptop PC

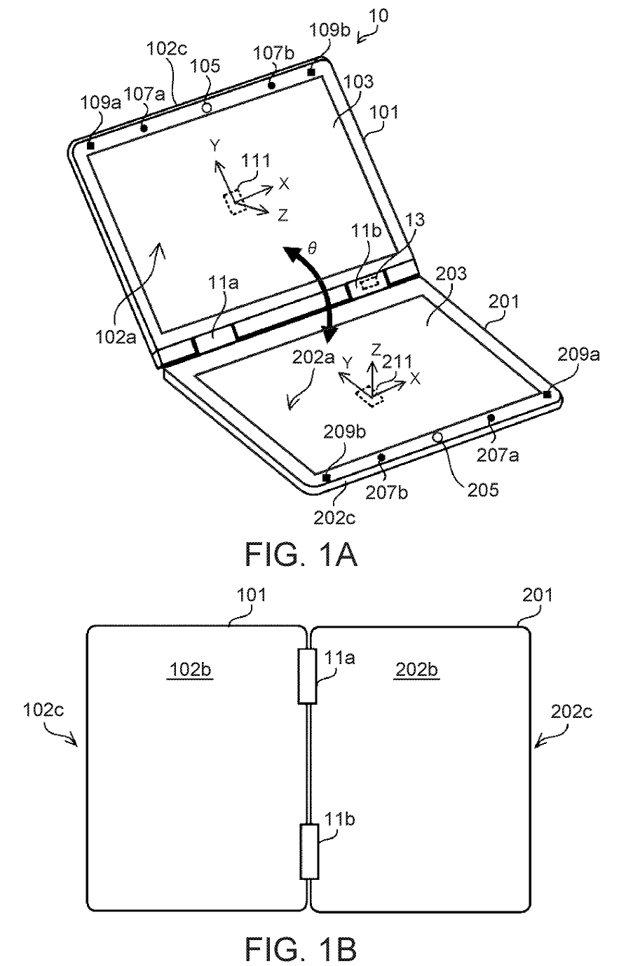

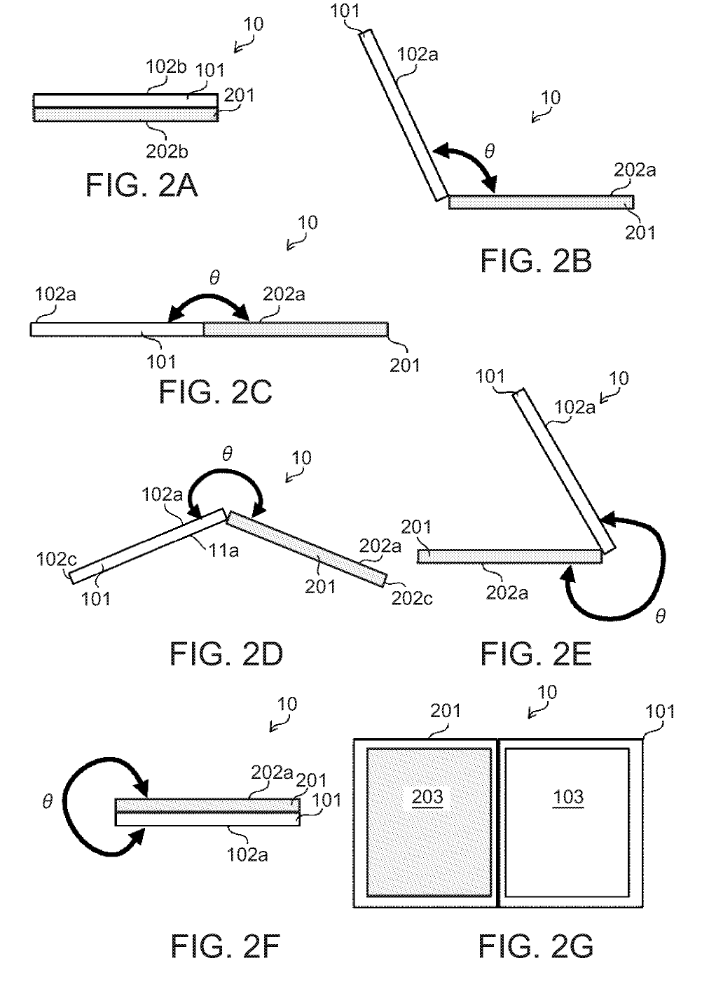

FIG. 1 is a perspective view and a back view illustrating a dual-screen laptop PC 10 having a multi-use mode according to this embodiment. The multi-use mode is a function that can be used in a plurality of use modes by varying a relative position between a chassis on which a display is mounted and a chassis on which a keyboard (including a software keyboard) is mounted and a position or orientation with respect to a desk surface, as needed. A portable electronic device having the multi-use mode belongs to a category such as a tablet terminal, a smartphone, or the like in some cases, instead of the laptop PC. The multi-use mode of the laptop PC 10 will be described with reference to FIG. 2.

In the laptop PC 10, a top-side chassis 101 and a bottom-side chassis 201 are coupled to each other via hinge mechanisms 11a and 11b. The top-side chassis 101 houses a touch screen 103, and a bottom-side chassis 201 houses a touch screen 203. For the top-side chassis 101, there are defined a front surface 102a which corresponds to the display surface side of the touch screen 103, a back surface 102b which corresponds to the back side of the front surface 102a, and a side surface 102c which is located in the position opposite to the hinge mechanisms 11a and 11b.

For the bottom-side chassis 201, there are defined a front surface 202a which corresponds to the display surface side of the touch screen 203, a back surface 202b which corresponds to the back side of the front surface 202a, and a side surface 202c which is located in the position opposite to the hinge mechanisms 11a and 11b. On the front surface 102a, there are provided a camera 105, stereo speakers 107a and 107b, and a microphone pair 109a and 109b in the edge frame of the touch screen 103 adjacent to the side surface 102c. In the inside of the top-side chassis 101, there is provided a triaxial acceleration sensor 111 with the X-Y coordinates defined to be parallel to the front surface 102a.

On the front surface 202a, there are provided a camera 205, stereo speakers 207a and 207b, and a microphone pair 209a and 209b in the edge frame of the touch screen 203 adjacent to the side surface 202c. In the inside of the bottom-side chassis 201, there is provided a triaxial acceleration sensor 211 with the X-Y coordinates defined to be parallel to the front surface 202a. For example, the bottom-side chassis 201 is equipped with a motherboard with system devices such as the CPU, GPU, I/O controller, and the like mounted thereon, a battery unit, a power-supply unit, a heat radiation fan, and the like in the inside, by which the bottom-side chassis 201 is heavier in weight than the top-side chassis 101.

An angle formed between the front surface 102a of the top-side chassis 101 and the front surface 202a of the bottom-side chassis 201 is referred to as “opening and closing angle θ.” FIG. 1A illustrates a state where the opening and closing angle θ is 140 degrees, and FIG. 1B illustrates a state where the opening and closing angle θ is 180 degrees. The hinge mechanisms 11a and 11b are able to rotate the top-side chassis 101 within the range of the opening and closing angle θ of 0 to 360 degrees and to maintain the position of the chassis at an arbitrary opening and closing angle θ by giving an appropriate torque. In one example, the system calculates the opening and closing angle θ by using the acceleration sensors 111 and 211. The hinge mechanism 11b includes a hall sensor 13 for detecting the opening and closing angle θ such as 0, 180, or 360 degrees which are difficult to be calculated by the acceleration sensors 111 and 211. Note that, however, the device for detecting the opening and closing angle θ does not need to be limited to the acceleration sensor or the hall sensor in the present disclosure.

### Multi-Use Mode

FIG. 2 is a diagram for describing a multi-use mode. The laptop PC 10 can be used in seven use modes by varying the opening and closing angle θ and varying the entire position of the laptop PC 10 with respect to the desk surface at a predetermined opening and closing angle θ. The system is able to recognize the use mode by outputs from the acceleration sensors 111 and 211 and from the hall sensor 13. FIG. 2A illustrates a closed mode in which the laptop PC 10 is closed so that the opening and closing angle θ is set to a zero degree. In FIG. 2A, the touch screen 103 and the touch screen 203 are opposed to each other. Although the system can be used by wireless communication or by connecting an external input-output device, the touch screens 103 and 203 cannot be used.

FIG. 2B illustrates the laptop mode in which the laptop PC is opened at the opening and closing angle θ within a predetermined range. In the laptop mode, the laptop PC can be used with a software keyboard displayed on the touch screen 203 and with a browsing screen displayed on the touch screen 103. FIG. 2C illustrates a lay-flat mode in which the laptop PC is opened at the opening and closing angle θ of 180 degrees. In the lay-flat mode, for example, one user can view the same screen as the other user facing the user by displaying the screens displayed on the touch screens 103 and 203 in such a way that the vertical directions of the screens are opposite to each other. Alternatively, the touch screens 103 and 203 may be used as a single screen.

FIG. 2D illustrates the tent mode in which the laptop PC is opened at the opening and closing angle θ of more than 180 degrees and in which the laptop PC is arranged so that the back surfaces 102b and 202b face the desk surface with the corners of the side surfaces 102c and 202c in contact with the desk surface. In the tent mode, the touch screen 103 is able to be inclined so that the user can easily view the touch screen 103. Therefore, the tent mode is useful for a presentation or for a case where users facing each other view the same screen simultaneously. FIG. 2E illustrates the stand mode in which the laptop PC is opened at the opening and closing angle θ of more than 180 degrees and is placed so that one touch screen 203 is in contact with the desk surface. The stand mode is useful for a case of, for example, a video conference because the user is able to use the space in front of the touch screen 103 since the bottom-side chassis 201 is not located in the front side of the touch screen 103.

FIG. 2F illustrates the tablet mode in which the laptop PC is opened at the opening and closing angle θ of 360 degrees. In the tablet mode, the back surface 102b of the bottom-side chassis 101 is opposite to the back surface 202b of the top-side chassis 201 and the touch screens 103 and 203 face the outside. In the tablet mode, the user holds the laptop PC with his/her hand so that one of the front surfaces 102a and 202a faces the user, thereby enabling the user to view and operate the touch screens 103 and 203.

FIG. 2G illustrates a book mode in which the laptop PC is opened at the opening and closing angle θ of 90 to 180 degrees. The book mode is useful for browsing the screen as if the user reads vertically-written sentences of a book. The laptop PC 10 includes, as interface devices, touch screens 103 and 203, cameras 105 and 205, stereo speakers 107a and 107b, stereo speakers 207a and 207b, a microphone pair 109a and 109b, and a microphone pair 209a and 209b.

When having detected the use mode (i.e., use configuration), the system needs to configure these interface devices in such a way that the configurations vary according to which one of the front surfaces 102a and 202a faces the user or the environment corresponding to the direction opposite thereto. Having detected the laptop mode, the system displays, for example, a browsing screen on the touch screen 103 and displays a keyboard on the touch screen 203. Having detected the tent mode, the system stops, for example, the touch screen 103 and activates the touch screen 203.

Having detected the stand mode, the system activates, for example, the touch screen 103 and stops the touch screen 203. Alternatively, in the case where a user often uses the laptop PC with the other user facing the user, a screen is displayed on the touch screens 103 and 203 in a back-to-back state. Regarding the stereo speakers 107a and 107b and the stereo speakers 207a and 207b, horizontal panning is controlled by determining their orientation relative to the user.

Regarding the microphone pair 109a and 109b and the microphone pair 209a and 209b, the system, having detected the use mode, for example, identifies the microphone pair for collecting user's voice and the microphone pair for collecting voices of many surrounding users and then controls beam forming so as to optimize the direction of the directional axis and the directional range angle of the emphasis space for each. In one example, the system decreases the directional range angle of the microphone pair for collecting the user's voice and increases the directional range angle of the microphone pair for collecting sounds from the environment.

Among the interface devices mounted on the portable electronic device in the multi-use mode, the devices requiring configuration after identifying the front surfaces 102a and 202a facing the users as described above will be referred to as directional devices. Alternatively, for configuration of the directional devices, the default settings are made if one of the front surfaces 102a and 202a faces the user and a setting other than the default settings are made if the other front surface faces the user. The touch screens 103 and 203, cameras 105 and 205, stereo speakers 107a and 107b, stereo speakers 207a and 207b, microphone pair 109a and 109b, and microphone pair 209a and 209b are only illustrative as examples of directional devices.

In the laptop mode, lay-flat mode, tent mode, and stand mode, the opening and closing angle θ is wide and therefore the user is able to recognize the bottom-side chassis 201 heavy in weight and to arrange the laptop PC on the desk even if the bottom-side chassis 201 and the top-side chassis 101 have uniformity in design. Therefore, the system is able to configure the directional devices according to the detected use mode assuming which one of the front surfaces 102a and 202a the user turns to him/herself.

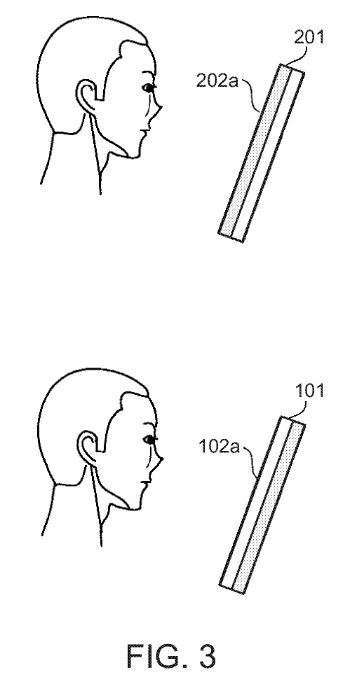

In the tablet mode, however, the opening and closing angle θ is 360 degrees and therefore the user cannot recognize the top-side chassis 101 and the bottom-side chassis 201 by weight. Furthermore, if the laptop PC has uniformity in design as a whole, it is difficult to hold the laptop PC while distinguishing between the touch screens 103 and 203 in a short time. If the user holds the chassis at that time, the front surface 202a or the front surface 102a faces the user as illustrated in FIG. 3. Although it is possible to previously determine one of the touch screens 103 and 203 as a touch screen to be activated in the tablet mode and to make settings coincident with the above determination for other directional devices, this method requires the user to hold the chassis again appropriately or requires the user to perform a setting operation. Therefore, in this embodiment, the system determines the front surface 102a or 202a facing the user or environment and makes settings of the devices.

### Setting of Directional Devices in Tablet Mode

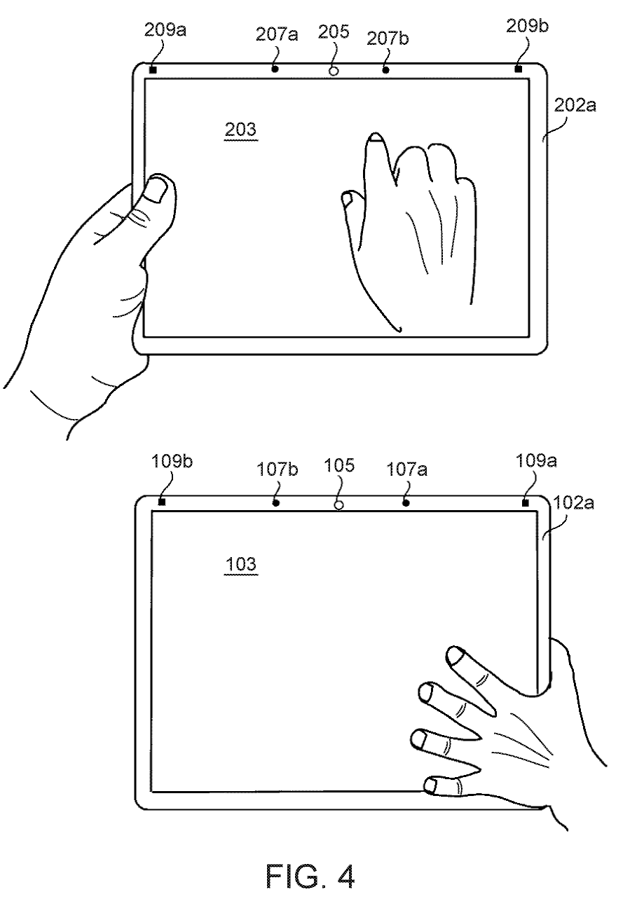

In the case where the user freely holds the laptop PC without regard to the front and rear direction and the top and bottom direction of the chassis in the tablet mode, there are a plurality of patterns for the relative orientation and position of the directional device to the user. FIG. 4 illustrates a state where the user holds the laptop PC 10 in the tablet mode with his/her left hand while operating the laptop PC 10 with his/her right hand.

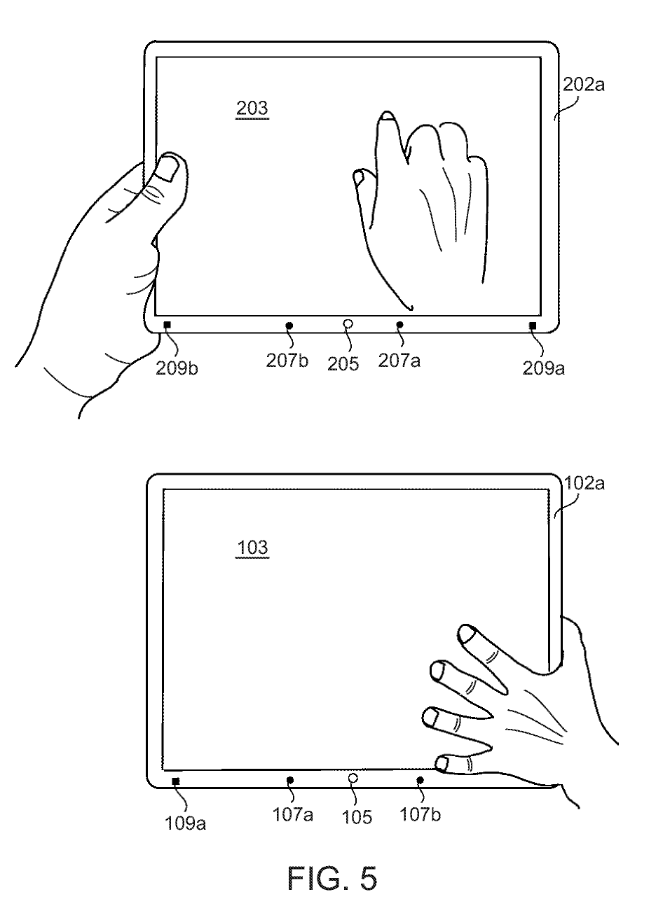

In FIG. 4, the front surface 202a faces the user, the front surface 102a faces the environment, and the cameras 105 and 205 are located on the upper side viewed from the user. Although the front surface 202a faces the user and the front surface 102a faces the environment also in FIG. 5, the top and bottom direction is opposite to that of FIG. 4 and therefore the cameras 105 and 205 are located on the lower side. Also when the front surface 102a faces the user, there are two types of top and bottom direction similarly. The notable aspect with respect to the top and bottom direction is that the right-and-left arrangement relationship of the stereo speakers 207a and 207b with respect to the user in FIG. 4 is opposite to that of FIG. 5.

In this situation, the system configures the directional devices by determining the orientation of the front surfaces 102a and 202a to the user or to the environment and the top and bottom direction (hereinafter, referred to as orientation to the user or the orientation to the environment) at the time point when the user holds the chassis in a method described later. In the tablet mode, the front surface facing a user and the front surface facing the environment are located in positions opposite to each other. Therefore, if the direction of one front surface is settled, the direction of the other front surface is also settled. Although the following describes configuring directional devices arranged on front surface 202a facing the user in (see FIGS. 4 and 5), the description below also applies when the front surface 102a is facing the user.

The following describes the preferable actions of the directional devices according to their orientation to the user in the tablet mode. If it is presupposed that the touch screens 103 and 203 provide an equal interface to the user, preferably only the touch screen facing the user is activated and the touch screen facing the environment is stopped from a viewpoint of preventing an erroneous operation or of power consumption.

Camera photographing includes self-photographing in which a user photographs himself/herself in voice speech (VoIP) and environment photographing in which a user photographs a still image or a moving image of the user's surroundings. In the camera photographing, a preview screen is displayed on the touch screen facing the user. For a user who uses the camera for environment photographing in most cases, it is convenient that the system activates the camera 105 provided on the front surface 102a facing the environment and displays the preview screen on the touch screen 203 provided on the front surface 202a facing the user when the user touches the icon of the camera.

For a user who uses the camera for self-photographing in most cases, it is convenient that the system activates the camera 205 provided on the front surface 202a facing the user and displays the preview screen on the touch screen 203 when the user touches the icon of the camera. In a low-cost laptop PC, for example, only the camera 105 on the top-side chassis 101 is provided in some cases to reduce the number of cameras. Although the user needs to change the holding style of the chassis according to whether the camera is used for the environment photographing or for the self-photographing, the preview screen needs to be displayed always on the touch screen facing the user. The touch screen 103 for displaying the preview screen and the camera 105 are present on the same front surface 102a in the self-photographing, while the front surface 202a of the touch screen 203 for displaying the preview screen is different from the front surface 102a where the camera is present in the environment photographing. Therefore, the system needs to detect the directions of the front surfaces 102a and 202a to the user.

Moreover, for a user who uses the camera by himself/herself in most cases, it is preferable that the system activates the stereo speakers 207a and 207b facing the user and stops the stereo speakers 107a and 107b facing the environment at the time of setting the tablet mode. Alternatively, for a user whose voice is often listened to by a plurality of users, it is preferable that the system activates the stereo speakers 107a and 107b in addition to the stereo speakers 207a and 207b at the time of setting the tablet mode. Furthermore, for the stereo speakers 207a and 207b, the system needs to change the horizontal panning according to the top and bottom direction as apparent from the horizontal arrangement in FIGS. 4 and 5.

In the case of frequently collecting voices generated by a user and a plurality of users nearby, it is desirable that the system controls beam forming so that the microphone pair 209a and 209b facing the user is suitable for collecting the user's voice and the microphone pair 109a and 109b facing the environment is suitable for collecting voices in a wide range. Alternatively, for a user who uses the camera by himself/herself in most cases, it is desirable that the system performs the beam-forming control for the microphone pair 209a and 209b facing the user and stops the microphone pair 109a and 109b facing the environment. As described above, in the tablet mode, the system needs to configure the directional devices according to the direction thereof to the user when the user holds the chassis.

### Method of Detecting Orientation to User

The system recognizes the orientation of directional devices to the user in the following method in order to configure the directional devices. As illustrated in FIGS. 4 and 5, a general user holds a right or left end of the chassis with one hand while performing a touch operation with the other hand in the tablet mode. Each of FIGS. 4 and 5 illustrates a situation where the touch screen 203 is held with the user's left thumb and the touch screen 103 is held with his/her remaining four fingers.

From a viewpoint of the structure of fingers, it can be considered that each of most users holds the touch screen 203 present on the front surface 202a facing the user with only his/her thumb. The number of fingers holding the touch screen 103 present on the front surface 102a facing the environment may depend on the size of the chassis. If the chassis is large, the chassis can be stably held with four fingers as illustrated in FIGS. 4 and 5. If the chassis is small, the chassis may be held with three fingers, namely the forefinger, middle finger, and annular finger or with two fingers, namely the forefinger and middle finger. Note here that, however, the chassis is not stable if the touch screen 103 is held with one finger as if the chassis were pinched between the finger and the thumb, and therefore it can be considered that normally this holding style would not be employed.

Characteristically, the thumb holds the peripheral portion of the touch screen 203. The remaining four fingers hold the touch screen 103 with the fingers alongside each other almost in the vertical direction along the lengths of the fingers. When the touch screens 103 and 203 detect some coordinates, the system recognizes the ball of a finger in a known method from the size and shape of the set of detected coordinates in an island shape. In this condition, if the touch screen 203 detects the coordinates of a recognized finger, the system assumes that the finger is the thumb and thus is able to determine that the front surface 202a on which the touch screen 203 is present faces the user. Moreover, additionally it may be added as a determination element that the coordinates are present in the peripheral portion of the touch screen 203. The system is able to determine that the touch screen 103, which has detected the coordinates by which a plurality of fingers are recognized, faces the environment. Additionally, it may be added as a determination element whether or not the arrangement of a plurality of sets of island-shaped coordinates follows the shapes of the fingers.

Furthermore, when only viewing the touch screen 203 or listening to music, the user sometimes temporarily uses his/her right hand to hold the opposite peripheral portions of the touch screens 203 and 103 like his/her left hand. In this case, the system recognizes one finger on each of both sides of the touch screen 203. If recognizing two fingers, the system is able to recognize the touch screen 203 facing the user by adding a fact that the coordinates of the fingers are present in areas of the peripheral portions on both sides of the touch screen 203 to determination elements. Also regarding the touch screen 103, if recognizing five or more fingers, the system is able to recognize the touch screen 103 facing the environment by adding whether or not the arrangement of a plurality of sets of island-shaped coordinates detected in the peripheral portions on both sides follows the shape of the respective fingers to the determination elements.

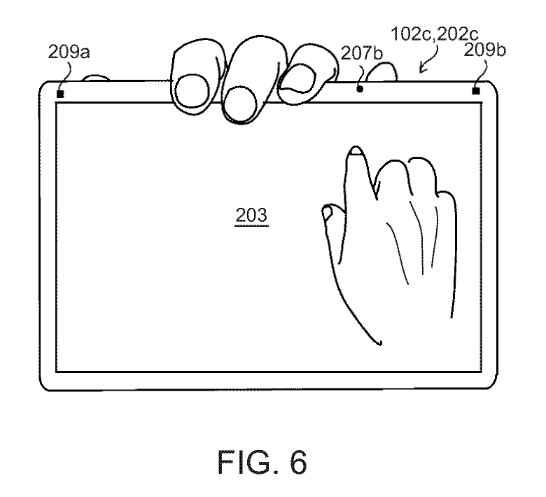

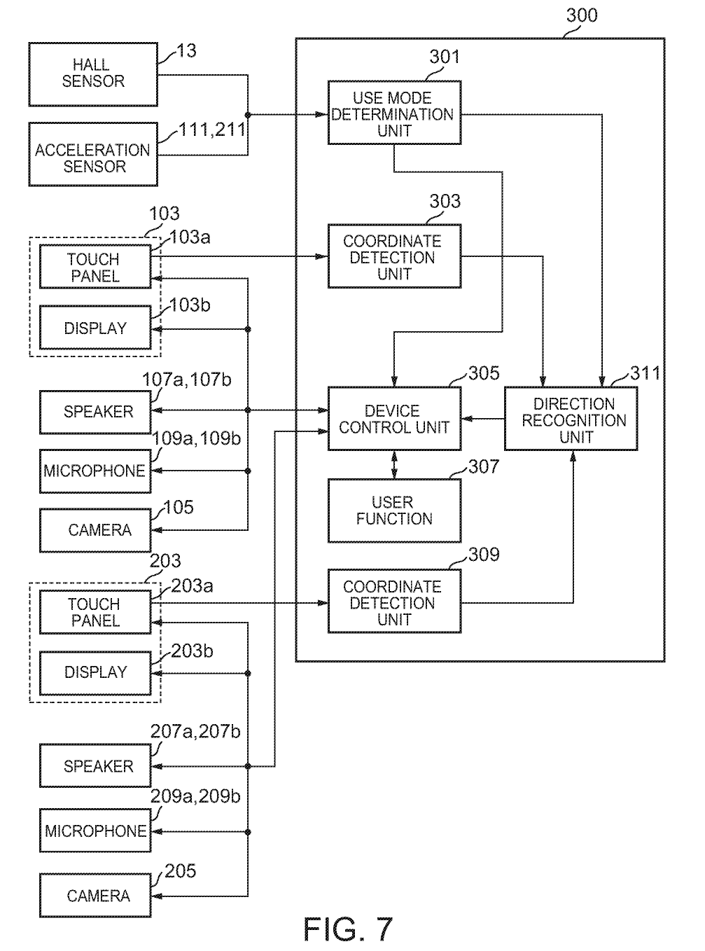

The system may determine the orientation of directional devices to the user on the basis of the number of fingers recognized by one of the touch screens 203 and 103, the coordinates of the touch positions of the fingers, the adequateness to the shape of the fingers, and the like or may settle the direction if the results of determination by both touch screens are the same. FIG. 6 illustrates a state where the user holds the side surfaces 102c and 202c of the chassis with his/her left hand. In this example, the user holds the vicinity of the side surfaces 102c and 202c with his/her five fingers of the left hand as if the user were holding the front surface 102a from the bottom thereof. As illustrated in FIG. 7, the touch screen 103 includes a touch panel 103a and a display 103b and the touch screen 203 includes a touch panel 203a and a display 203b.

The areas of the touch panels 103a and 203a can be extended to the vicinity of the side surfaces 102c and 202c so as to be larger than the areas of the displays 103b and 203b. In FIG. 6, the system recognizes the forefinger, middle finger, and annular finger of the left hand from the coordinates of the touch panel 203a and recognizes the thumb and the little finger from the coordinates of the touch panel 103a. Characteristically, the palm of the left hand and the roots of the fingers are in contact with the touch panel 103a. When the user holds the laptop PC as illustrated in FIG. 6, the system is able to determine that the front surface 102a faces the environment by recognizing the palm of the hand from the coordinates of the touch panel 103a.

### Control System

FIG. 7 is a schematic functional block diagram of a control system 300 that configures directional devices by detecting a use mode. The hall sensor 13 and the acceleration sensors 111 and 121 are illustrative only of the devices which output signals for identifying the use mode. The touch panels 103 and 203, the cameras 105 and 205, the stereo speakers 107a and 107b, the stereo speakers 207a and 207b, the microphone pair 109a and 109b, and the microphone pair 209a and 209b are connected to the control system 300.

The touch panels 103a and 203a are illustrative only of the devices which detect the coordinates of the fingers that have touched the touch panels, and it is possible to use a touch sensor of the electrostatic capacitance type, infrared type, electromagnetic induction type, resistive film type, or the like. A use mode determination unit 301, a coordinate detection unit 303, a device control unit 305, a user function 307, a coordinate detection unit 309, and a direction recognition unit 311 constituting the control system 300 are able to be formed in combination between hardware resources such as a CPU, system memory, and chipset and software resources such as a device driver, OS, and application program. The software resources are stored in a disc drive or non-volatile memory housed in the laptop PC 10.

The use mode determination unit 301 determines the opening and closing angle θ and the position of the chassis relative to the direction of gravitational force on the basis of the signals received from the hall sensor 13 and the acceleration sensors 111 and 121 and recognizes the use mode. If the recognized new use mode is the tablet mode, the use mode determination unit 301 notifies the direction recognition unit 311 of the identifier of the tablet mode. If the recognized new use mode is other than the tablet mode, the use mode determination unit 301 notifies the device control unit 305 of the identifier of the recognized use mode.

The coordinate detection units 303 and 309 send the coordinates detected by the touch panels 103a and 203a respectively to the direction recognition unit 311. The device control unit 305 configures the directional devices on the basis of the identifier of the use mode received from the use mode determination unit 301 or the direction recognition unit 311. The user function 307 sends image data displayed on the touch screens 103 and 203, sound data output from the microphones 109a, 109b, 209a, and 209b, and the like to the device control unit 305.

The device control unit 305 sends the received image data and sound data to the displays 103b and 203b, the stereo speakers 107a and 107b, and the stereo speakers 207a and 207b for which configurations have been made. The device control unit 305 sends the sound data received from the microphone pair 109a and 109b and the microphone pair 209a and 209b for which configurations have been made and the image data received from the cameras 105 and 205 for which configurations have been made to the user function 307. The user function 307 records the received sound data and image data into the non-volatile memory. The user is able to set the photographing mode for the device control unit 305. In the case of frequently performing environment photographing, the user sets the environment photographing mode. In the case of frequently performing user photographing, the user sets the user photographing mode.

### Action of Control System

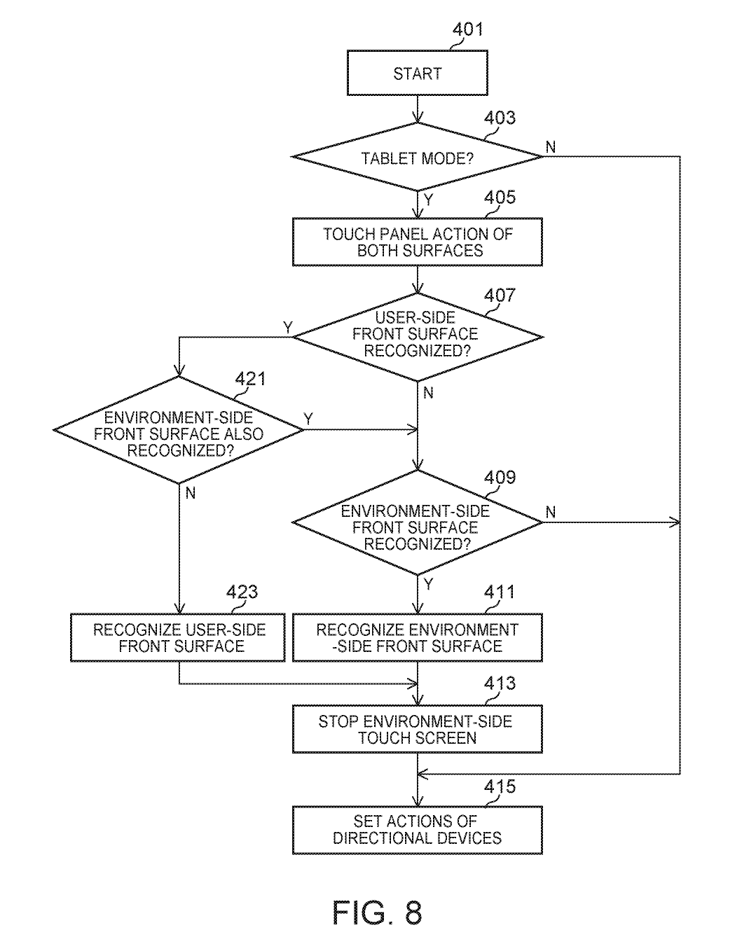

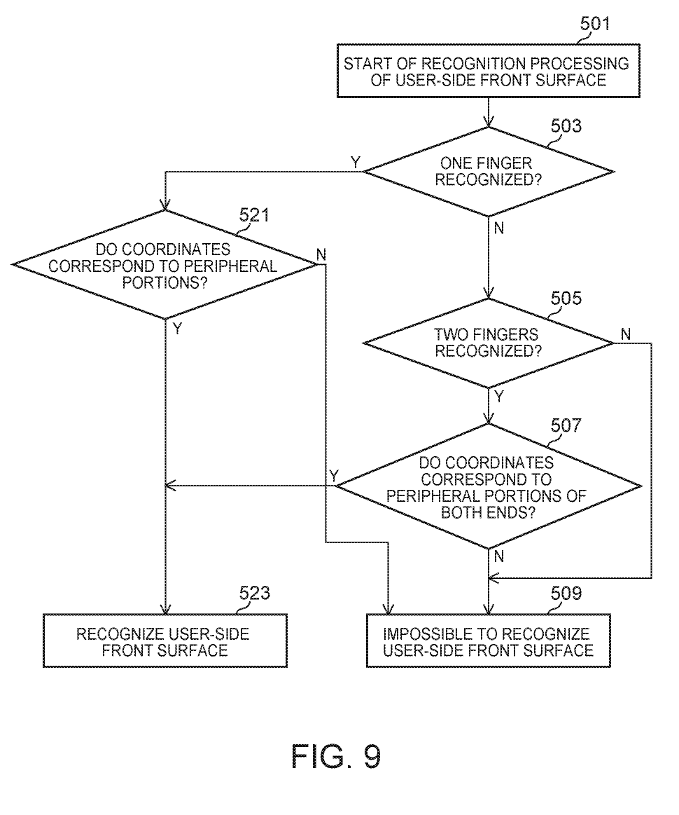

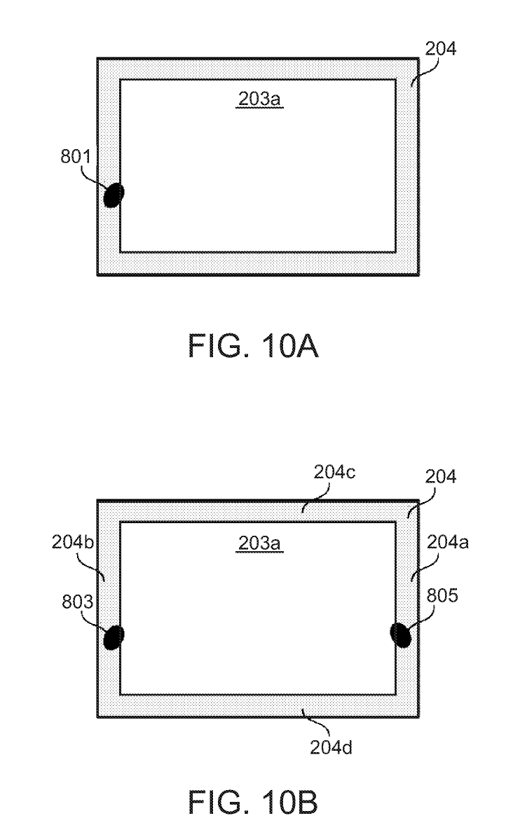

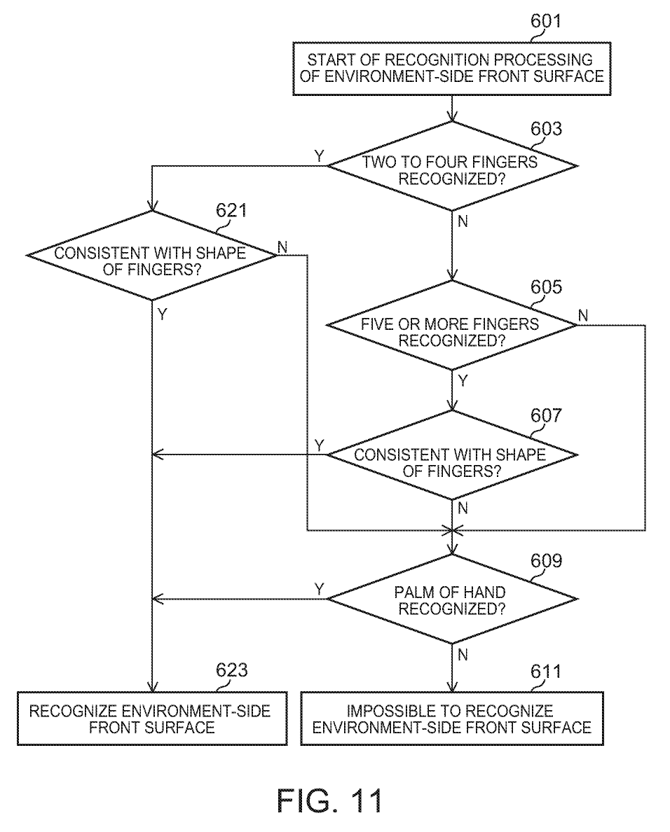

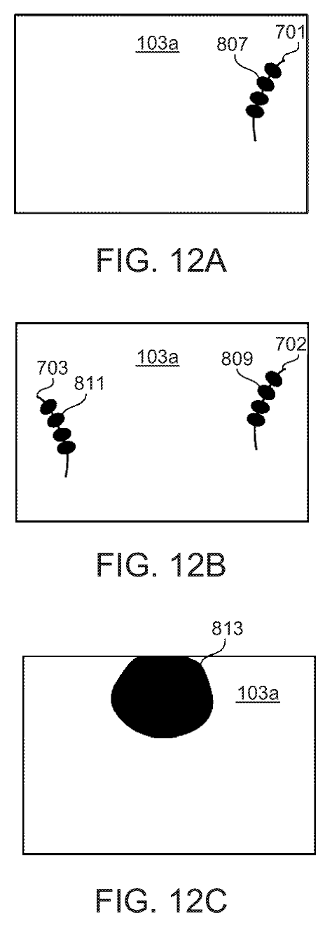

FIG. 8 is a master flowchart illustrating an action procedure for a control system 300. FIG. 9 is a flowchart illustrating a procedure for recognizing the front surface facing the user. FIG. 10 is a diagram for describing a procedure for recognizing the front surface facing the user. FIG. 11 is a flowchart illustrating a procedure for recognizing the front surface facing an environment. FIG. 12 is a diagram for describing a procedure for recognizing the front surface facing the environment.

In block 401, the laptop PC 10 is operating in one of the use modes. In block 403, the user changes the opening and closing angle θ and the position to the desk surface and then changes the use mode to one other than the closed mode. If the use mode recognized based on the outputs from the acceleration sensors 111 and 211 and the hall sensor 13 is other than the tablet mode, the use mode determination unit 301 notifies the device control unit 305 of the identifier of the recognized use mode and then proceeds to block 415.

If the recognized use mode is the tablet mode, the use mode determination unit 301 notifies the direction recognition unit 311 of the identifier of the tablet mode and then proceeds to block 405. In the block 415 following the block 403, the device control unit 305 configures the directional devices so as to correspond to their orientation to the user that has been previously assumed for the use mode other than the tablet mode.

In the block 405, the direction recognition unit 311 sends the identifier of the tablet mode to the device control unit 305. Upon receiving the identifier, the device control unit 305 activates a touch screen if it is stopped. Note that, however, the displays 103b and 203b need not be activated until the direction recognition unit 311 identifies the front surface facing the user or the front surface facing the environment. Therefore, the device control unit 305 may activate only the touch panels 103a and 203a at the time of receiving the identifier of the tablet mode and then activates the touch screen 103 or 203 facing the user in block 413 after receiving the identifier indicating the front surface from the direction recognition unit 311 while stopping the other touch screen 103 or 203.

The coordinate detection units 303 and 309 send the coordinates of the touched positions to the direction recognition unit 311 independently of each other. The direction recognition unit 311 starts processing of identifying the front surface facing the user and the front surface facing the environment with respect to the coordinates received from the coordinate detection units 303 and 309. If the direction recognition unit 311 recognizes the front surface facing the user on the basis of the coordinates detected by one of the touch panels 103a and 203a in block 407, the processing proceeds to block 421. Unless the direction recognition unit 311 recognizes the front surface facing the user, the processing proceeds to block 409. The procedure of the block 407 will be described with reference to FIG. 9. If the user previously makes a setting of settling the direction to the user after recognizing both of the front surface facing the user and the front surface facing the environment for the direction recognition unit 311 in the block 421, the processing proceeds to the block 409. If the user makes a setting of recognizing only the front surface facing the user, the processing proceeds to block 423.

In the block 423, the direction recognition unit 311 sends the identifier indicating one of the front surfaces 102a and 202a where a touch panel that has recognized the front surface facing the user is present to the device control unit 305. If the direction recognition unit 311 recognizes the front surface facing the environment on the basis of the coordinates detected by one of the touch panels 103a and 203a in the block 409, the processing proceeds to block 411. Unless the direction recognition unit 311 recognizes the front surface facing the environment, the processing proceeds to the block 415. The procedure of the block 409 will be described with reference to FIG. 10.

Unless receiving the identifier indicating one of the front surfaces 102a and 202a even after a fixed time has elapsed after receiving the notification of the tablet mode in the block 415 following the block 409, the device control unit 305 considers one of the front surfaces 102a and 202a previously set for the tablet mode to be a front face facing the user and configures the directional devices.

In block 411, the direction recognition unit 311 sends the identifier indicating one of the front surfaces 102a and 202a where the touch panel, which has recognized the front surface facing the environment, is present to the device control unit 305. In the path to the block 413, the direction recognition unit 311 recognizes the front surface facing the user and the front surface facing the environment or one of the front surfaces and thus consequently recognizes which of the user and the environment the front surfaces 102a and 202a face, respectively. In block 413, the device control unit 305 stops the touch screen facing the environment to prevent a subsequent occurrence of an erroneous input and to reduce power consumption. In the block 415, the device control unit 305 configures the directional devices other than the touch screens 103 and 203 so as to adapt to their orientation relative to the user.

In block 501 of FIG. 9, the direction recognition unit 311 starts the processing for recognizing the front surface facing the user on the basis of the coordinates received from each of the coordinate detection units 303 and 309. If the front surface 202a faces the user and the front surface 102a faces the environment and if the direction recognition unit 311 recognizes one finger from the set 801 of the coordinates detected by the touch panel 203a as illustrated in FIG. 10A in block 503, the processing proceeds to block 521. Unless the direction recognition unit 311 recognizes one finger, the processing proceeds to block 505.

As illustrated in FIG. 10A, the direction recognition unit 311 is able to define a coordinate area 204 around the touch panel 203a in order to increase the recognition accuracy of the front surface facing the user. If the coordinate area 204 is defined, it is determined whether or not at least a part of the finger is recognized in the coordinate area 204 from the set 801 of the recognized coordinates in the block 521. Unless the coordinate area 204 is defined, the procedure of the block 521 is skipped.

If one finger is recognized in the coordinate area 204, it is determined that one peripheral portion of the touch panel 203a is held and the processing proceeds to block 523. Unless one finger is recognized in the coordinate area 204, the processing proceeds to block 505. In the block 523, the direction recognition unit 311 recognizes that the front surface 202a where the touch panel 203 is present faces the user. If the direction recognition unit 311 recognizes two fingers from the sets 803 and 805 of coordinates detected by the touch panel 203a as illustrated in FIG. 10B in the block 505, the processing proceeds to block 507. Otherwise, the processing proceeds to block 509.

Since the direction recognition unit 311 cannot recognize the front surface facing the user in the block 509, the procedure proceeds from the block 407 to the block 409. In the block 507, the direction recognition unit 311 determines whether or not at least a part of each finger is recognized in the coordinate areas 204a and 204b at both ends of the touch panel 203a from the sets 803 and 805 of the coordinates recognized by the touch panel 203a as illustrated in FIG. 10B. If two fingers are recognized in the coordinate areas 204a and 204b, it is determined that the peripheral portions at both ends of the touch panel 203a are held and then the processing proceeds to the block 523. Unless two fingers are recognized in the coordinate areas 204a and 204b, the processing proceeds to block 509. The direction recognition unit 311 may also determine that the peripheral portions at both ends are held when two fingers are recognized in coordinate areas 204c and 204d. Incidentally, unless the coordinate area 204 is defined, the procedure of the block 507 is skipped.

In block 601 of FIG. 11, the direction recognition unit 311 starts processing for recognizing the front surface facing the environment on the basis of the coordinates received from each of the coordinate detection units 303 and 309. In block 603, the direction recognition unit 311 proceeds to block 621 if two to four fingers are recognized from a set 807 of coordinates on the touch panel 103a and otherwise proceeds to block 605. FIG. 12A illustrates the touch positions of four fingers of the left hand.

The direction recognition unit 311 retains data of a line 701 along a standard arrangement of fingers detected by the touch panel 103a facing the environment when a user holds the chassis with one hand as illustrated in FIG. 12A. In the block 621, the direction recognition unit 311 determines whether or not the set 807 of a plurality of recognized discrete coordinates is formed along the shape of the fingers. The direction recognition unit 311 compares the line 701 with the set 807 of the plurality of coordinates, and if determining that the position of the set 807 of the plurality of coordinates is consistent with the shape of the fingers, the direction recognition unit 311 determines that the user holds the chassis with one hand and proceeds to block 623, or otherwise, proceeds to block 609. The comparison between the line 701 and the set 807 of the coordinates can be performed, for example, by calculating the degree of approximation of a line connecting the center of gravity of the set 807 of the respective coordinates to the line 701. The procedure of the block 621 can be skipped.

In the block 605, the direction recognition unit 311 proceeds to block 607 if recognizing five or more fingers from sets 809 and 811 of the coordinates present in a plurality of discrete positions on the touch panel 103a as illustrated in FIG. 12B, or otherwise, proceeds to the block 609. The sets 809 and 811 of the coordinates in FIG. 12B each represent the touch positions of four fingers of the right or left hand. The direction recognition unit 311 retains data of lines 702 and 703 along a standard arrangement of fingers detected by the touch panel 103a facing the environment when a user holds the chassis with both hands.

In the block 607, the direction recognition unit 311 determines whether or not the positions of the sets 809 and 811 of the plurality of recognized discrete coordinates are arranged along the shape of the fingers when the chassis is held with both hands. The direction recognition unit 311 compares the lines 702 and 703 with the sets 809 and 811 of the plurality of coordinates. If determining that the positions of the sets 809 and 811 of the plurality of coordinates are consistent with the shape of the fingers holding the chassis at both ends thereof, the direction recognition unit 311 determines that the user holds the chassis with both hands and proceeds to the block 623. Otherwise, the direction recognition unit 311 proceeds to the block 609. The procedure of the block 607 can be skipped.

If recognizing the palm of a hand from a set 813 of cohesive coordinates detected by the touch panel 103a as illustrated in FIG. 12C in the block 609, the direction recognition unit 311 proceeds to the block 623. Otherwise, the direction recognition unit 311 proceeds to block 611. In the block 611, the direction recognition unit 311 cannot recognize the front surface facing the environment and therefore the procedure proceeds from the block 409 to the block 415 in FIG. 8.

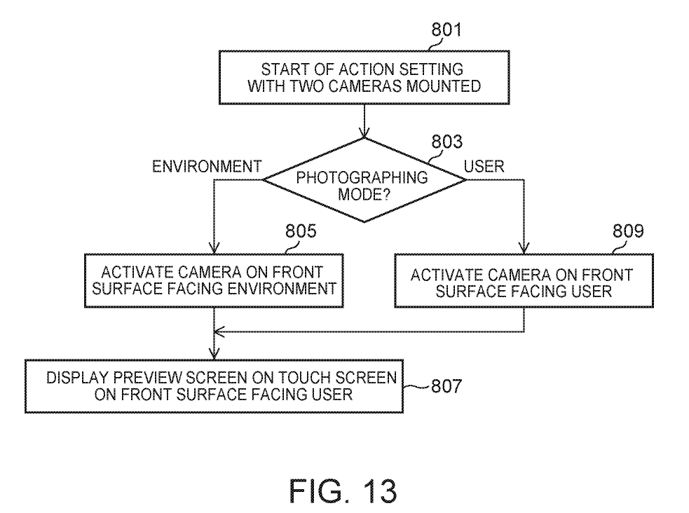

FIG. 13 is a flowchart illustrating a procedure for configuring cameras 105 and 205. In the case where the laptop PC 10 is equipped with two cameras, the user is allowed to previously set a frequently-used photographing mode in the device control unit 305. In block 801, the user starts photographing by touching a start object for a camera displayed on the touch screen 203 facing the user. In block 803, the device control unit 305 proceeds to block 805 if determining that the currently-set photographing mode is the environment photographing mode or proceeds to block 809 if determining that the currently-set photographing mode is the user photographing mode.

In the block 805, the device control unit 305 activates the camera 105 present on the front surface 102a facing the environment recognized on the basis of the identifier indicating one of the front surfaces received from the direction recognition unit 311. In block 807, the device control unit 305 displays a preview screen of the camera 105 on the touch screen 203 present on the front surface 202a facing the user. The device control unit 305 activates the camera 205 present on the front surface 202a facing the user recognized on the basis of the identifier indicating one of the front surfaces received from the direction recognition unit 311 in the block 809 and displays the preview screen of the camera 205 on the touch screen 203 in the block 807. According to this procedure, the user is able to use the previously-set photographing mode without performing a particular operation other than the start operation when holding the chassis without regard to the direction of the camera.

Also in the case where the laptop PC is equipped with only a single camera, a user is able to easily perform environment photographing or user photographing by applying the present disclosure. For example, in the case where the camera 105 is mounted only on the top-side chassis 101, the user holds the chassis with the front surface 102a facing the environment when photographing the environment. Upon receiving the identifier indicating one of the front surfaces from the direction recognition unit 311, the device control unit 305 displays a preview screen on the touch screen 203 present on the front surface 202a facing the user.

Moreover, when photographing the user, the user holds the chassis with the front surface 102a facing the user. Upon receiving the identifier indicating one of the front surfaces from the direction recognition unit 311, the device control unit 305 displays a preview screen on the touch screen 103 present on the front surface 102a facing the user. Although the user needs to hold the chassis with the camera facing in the photographing direction in the case of a single camera, the present disclosure enables a preview screen to be displayed on the touch screen facing the user without fail even if the photographing is performed in any direction.

The procedures illustrated in FIGS. 8, 9, 11, and 13 illustrate merely examples of the actions of the control system 300. Therefore, it is possible to change the sequence or to skip some procedures within the spirit of the present disclosure. For example, in FIG. 8, the front surface facing the environment may be recognized before the recognition of the front surface facing the user. Moreover, the procedure of the block 421 in FIG. 8 may be omitted and an orientation relative to the user may be determined by recognizing the front surface facing the user or the front surface facing the environment.

Although the present embodiments have been described by exemplifying the laptop PC 10 in the multi-use mode where the top-side chassis 101 and the bottom-side chassis 201 are coupled to each other via the hinge mechanisms 11a and 11b, the portable electronic device is not limited to the embodiments, regarding the portable electronic device in which touch sensors are arranged back to back in a used state in which the chassis is held with hands. For example, the present disclosure is applicable to a portable electronic device in which the top-side chassis 101 can be detachably attached as an auxiliary touch screen so that the back surface 102b is brought into contact with the back surface 202b of the bottom-side chassis 201. Moreover, the present disclosure is applicable to a flexible foldable tablet terminal in which two touch screens can be folded and arranged back to back. In both cases, in a back-to-back state, the display surface side of one touch screen corresponds to the front surface 102a of the laptop PC 10 and the display surface side of the other touch screen corresponds to the front surface 202a.

Although the present disclosure has been described with particular embodiments illustrated in appended drawings, the present disclosure is not limited to the embodiments illustrated in the drawings. As long as the advantageous effects of the present disclosure are provided, naturally any configuration having been known heretofore can be employed.

What is claimed is:

1. A portable electronic device comprising:
a first and a second chassis, each chassis comprising:
a front surface and a back surface;
a directional device arranged on the front surface of the chassis;
a touch sensor arranged on the front surface of the chassis; and
a control unit that determines an orientation of each front surface to a user, and in response, configures the directional device arranged on each front surface.

2. The portable electronic device of claim 1, wherein:
each directional device comprises a touch screen; and
each touch sensor comprises a touch panel that includes the touch screen.

3. The portable electronic device of claim 2, wherein the first chassis and the second chassis are coupled to each other via a hinge mechanism, wherein a use configuration of the portable electronic device is set in response to the rotation of the hinge mechanism.

4. The portable electronic device of claim 1, wherein the control unit determines an orientation of each front surface to a user comprises the touch sensors on each front surface detecting the number of fingers touching the front surface.

5. The portable electronic device of claim 4, wherein the control unit recognizes that a front surface is oriented toward the user in response to the touch sensor arranged on the front surface detecting a single finger touching a periphery of the front surface.

6. The portable electronic device of claim 4, wherein the control unit recognizes that a front surface is oriented toward the user further in response to the touch sensor arranged on the front surface detecting a first finger and a second finger touching a periphery of the front surface, wherein the first finger and the second finger touch the periphery on opposite ends of the front surface.

7. The portable electronic device of claim 4, wherein the control unit recognizes that a front surface is oriented away from the user in response to the touch sensor arranged on the front surface detecting two to four fingers touching the front surface.

8. A method for configuring a directional device arranged on a front surface of a portable electronic device, wherein the portable electronic device comprises a first chassis and a second chassis, each chassis comprising a front surface and a back surface, a directional device arranged on the front surface, and a touch sensor arranged on the front surface, the method comprising:
detecting an orientation of each front surface to a user; and
configuring the directional device arranged on each front surface in response to detecting the orientation of the front surface.

9. The method of claim 8, wherein:
each directional device comprises a touch screen; and
each touch sensor comprises a touch panel that includes the touch screen.

10. The method of claim 9, wherein the first chassis and the second chassis are coupled to each other via a hinge mechanism, wherein a use configuration of the portable electronic device is set in response to the rotation of the hinge mechanism.

11. The method of claim 8, wherein determining an orientation of each front surface to a user comprises detecting the number of fingers touching the front surface.

12. The method of claim 11, further comprising recognizing that a front surface is oriented toward the user in response to detecting a single finger touching a periphery of the front surface.

13. The method of claim 11, further comprising recognizing that a front surface is oriented toward the user further in response to detecting a first finger and a second finger touching a periphery of the front surface, wherein the first finger and the second finger touch the periphery on opposite ends of the front surface.

14. The method of claim 11, further comprising recognizing that a front surface is oriented away from the user in response to the touch sensor arranged on the front surface detecting two to four fingers touching the front surface.

15. A program product comprising a computer readable storage medium that stores code executable by a processor, the executable code comprising code to perform:
detecting an orientation of each front surface of a portable electronic device to a user, wherein the portable electronic device comprises a first chassis and a second chassis, each chassis comprising a front surface and a back surface, a directional device arranged on the front surface, and a touch sensor arranged on the front surface; and
configuring the directional device arranged on each front surface in response to detecting the orientation of the front surface.

16. The program product of claim 15, wherein:
each directional device comprises a touch screen; and
each touch sensor comprises a touch panel that includes the touch screen.

17. The program product of claim 16, wherein the first chassis and the second chassis are coupled to each other via a hinge mechanism, wherein a use configuration of the portable electronic device is set in response to the rotation of the hinge mechanism.

18. The program product of claim 15, wherein determining an orientation of each front surface to a user comprises detecting the number of fingers touching the front surface.

19. The program product of claim 18, the code further recognizing that a front surface is oriented toward the user in response to detecting a single finger touching a periphery of the front surface.

20. The program product of claim 18, the code further recognizing that a front surface is oriented toward the user further in response to detecting a first finger and a second finger touching a periphery of the front surface, wherein the first finger and the second finger touch the periphery on opposite ends of the front surface.
